(19) United States
(12) Patent Application Publication
(10) Pub. No.: US 2014/0283373 A1
(43) Pub. Date: Sep. 25, 2014

(54) Lamination for a Permanent Magnet Machine

(71) Applicant: Baldor Electric Company, Fort Smith, AR (US)

(72) Inventors: Michael J. Melfi, Richfield, OH (US); Richard F. Schiferl, Chagrin Falls, OH (US); Stephen D. Umans, Belmont, MA (US); Robert F. McElveen, Anderson, SC (US); William E. Martin, Greenville, SC (US)

(21) Appl. No.: 14/271,922

(22) Filed: May 7, 2014

Related U.S. Application Data
(63) Continuation-in-part of application No. 13/329,814, filed on Dec. 19, 2011.

(51) Int. Cl. H02K 15/03

(52) U.S. Cl. CPC H02K 15/03
USPC 29/598

(57) ABSTRACT

A method includes forming a lamination that may be used in a rotor of an interior permanent magnet motor or further processed for use in a line-start interior permanent magnet motor. The lamination has been optimized for low cogging, minimal usage of magnet material, and maximum torque per ampere and may be further processed to include rotor bars slots to allow the lamination's use in connection with an LSIPM. In accordance with the method, the lamination is formed with magnet slots that are radially inward of the outer diameter. The magnet slots are formed in a plurality of V-shaped arrangements. Each V-shaped arrangement has a leading edge and a trailing edge. The leading edge and trailing edge are arranged such that when the leading edge aligns with a stator tooth, the respective trailing edge is generally not aligned with a stator tooth.

### CROSS REFERENCE TO RELATED APPLICATIONS

This application is a continuation in part of application Ser. No. 13/329,814 filed Dec. 19, 2011, currently pending, the disclosure of which is incorporated by reference herein.

### STATEMENT REGARDING FEDERALLY SPONSORED RESEARCH OR DEVELOPMENT

This invention was made with Government support under agreement no. DE-FG36-08GO180132 awarded by the Department of Energy. The Government has certain rights in this invention.

### BACKGROUND

The disclosure relates to laminations that may be used for rotors in interior pole magnet (IPM) motors, and with subsequent operations to form rotor bar slots, the same laminations may be used for line-start, IPM motors. In other words, a lamination which has been optimized for use in a non-line start IPM motor for low cogging, minimal usage of magnet material, and maximum torque per ampere, may be further processed to include rotor bars slots to allow the lamination's use in connection with an LSIPM motor. This provides manufacturing flexibility in that the same lamination may be used in both applications (albeit modified through further processing in the LSIPM motor application) to provide efficient, power dense, and economical motors over previous designs.

### BRIEF DESCRIPTION OF THE DRAWINGS

FIG. 1 is a perspective view of a line start permanent magnet motor (a LSIPM motor);

FIG. 2 is a partial cross-section view of the motor of FIG. 1 along plane 2-2; and

FIG. 3 shows an illustrative embodiment of a lamination used in a rotor of an interior permanent magnet motor without line start capability (i.e., a non-line start IPM motor).

FIG. 4 shows an illustrative embodiment of the lamination of FIG. 3 after further processing for use in the LSIPM motor of FIG. 1.

### DETAILED DESCRIPTION

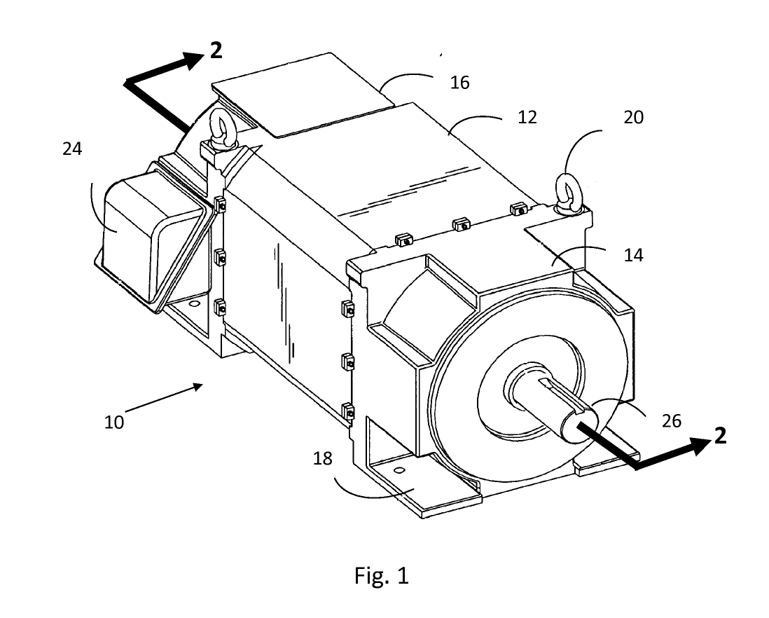

Turning to the drawings, FIG. 1 illustrates an exemplary electric motor 10. In the embodiment illustrated, the motor 10 comprises a line start permanent magnet motor. The exemplary motor 10 comprises a frame 12 capped at each end by drive and opposite drive end caps 14,16, respectively. The frame 12 and the drive and opposite drive end caps 14,16 cooperate to form the enclosure or motor housing for the motor 10. The frame 12 and the drive and opposite drive end caps 14,16 may be formed of any number of materials, such as steel, aluminum, or any other suitable structural material. The drive and opposite drive end caps 14,16 may include mounting and transportation features, such as the illustrated mounting feet 18 and eyehooks 20.

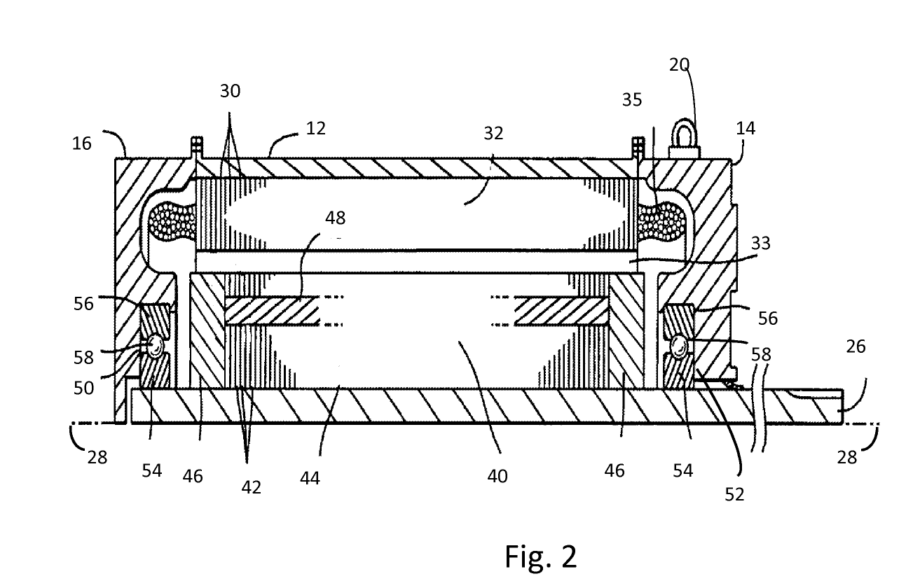

To induce rotation of the rotor, current is routed through stator windings disposed in the stator. (See FIG. 2). Stator windings are electrically interconnected to form groups. The stator windings are further coupled to terminal leads (not shown), which electronically connect the stator windings to an external power source (not shown), such as 480 VAC three-phrase power or 110 VAC single-phase power. A conduit box 24 houses the electrical connection between the terminal leads and the external power source. The conduit box 24 comprises a metal or plastic material, and advantageously, provides access to certain electrical components of the motor 10. Routing electrical current from its external power source through the stator windings produces a magnetic field that induces rotation of the rotor. A rotor shaft 26 coupled to the rotor rotates in conjunction with the rotor about a center axis 28. That is, rotation of the rotor translates into a corresponding rotation of the rotor shaft 26. As appreciated by those of ordinary skill in the art, the rotor shaft may couple to any number of drive machine elements, thereby transmitting torque to the given drive machine element. By way of example, machines such as pumps, compressors, fans, conveyors, and so forth, may harness the rotational motion of the rotor shaft 26 for operation.

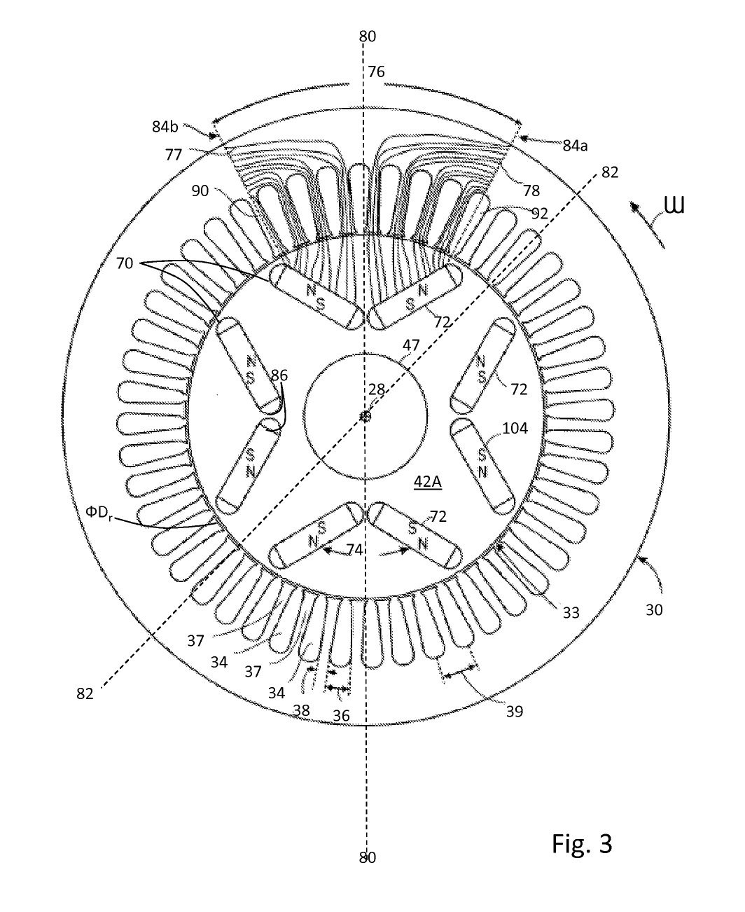

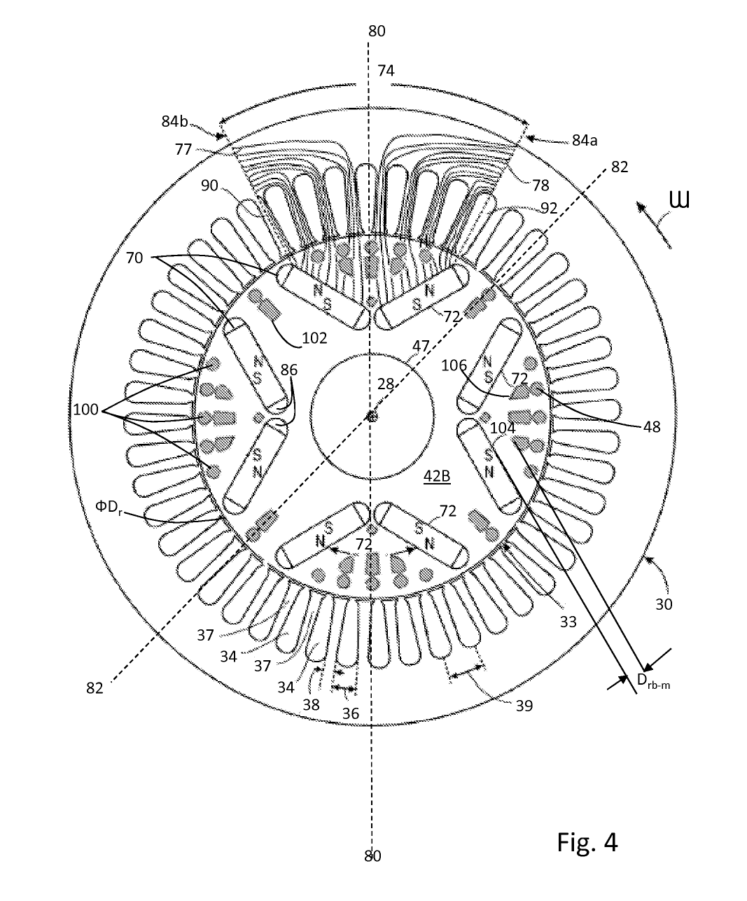

FIG. 2 is a partial cross-sectional view of the motor 10 of FIG. 1 along plane 2-2 of FIG. 1. To simplify the discussion, only the top portion of the motor 10 is shown, as the structure of the motor 10 is essentially mirrored along its centerline. As discussed above, the frame 12 and the drive and opposite drive end caps 14,16 cooperate to form an enclosure or motor housing for the motor 10. Within the enclosure or motor housing resides a plurality of stator laminations 30 placed next to and aligned with one another to form a lamination stack, such as a contiguous stator core 32. In the exemplary motor 10, the stator laminations 30 are substantially identical to one another, and each stator lamination 30 includes features that cooperate with adjacent laminations to form cumulative features for the contiguous stator core 32. For example, each stator lamination 30 includes a central aperture that cooperates with the central aperture of adjacent stator laminations to form a rotor chamber 33 that extends the length of the stator core 32 and that is sized to receive a rotor. Additionally, each stator lamination 30 includes a plurality of stator slots 34 (FIGS. 3 and 4) disposed circumferentially about the central aperture. These stator slots 34 cooperate to receive one or more stator windings 35, which are illustrated as coil ends in FIG. 2, that extend the length of the stator core 32. Referring to FIGS. 3 and 4, the stator slots 34 have a width 36 and define stator teeth 37 with a stator tooth width 38. Together the stator slot width 36 and stator tooth width 38 define a stator tooth pitch 39. The stator tooth width 38 and the stator slot width 36 are generally angular distances measured about the axis of rotation 28. The stator tooth pitch 39 generally corresponds to the distance between generally identical points of adjacent teeth or slots, e.g., centerline to centerline, or clockwise-most edge to clock-wise most edge.

As will be become apparent from the discussion that follows, the stator and rotor may be designed to limit cogging torque of motor and optimize steady state performance of the motor. Generally speaking, the stator teeth 37 (and winding slots 34) may alternate in a rotationally symmetric fashion about the center axis 28. The stator slots and teeth 34,37 may have a generally constant cross-sectional profile and may be evenly spaced circumferentially about the axis of rotation 28 as measured by a line passing through a line passing through a longitudinal axis of the slots or teeth. There may be as many teeth as slots (for instance, 24), and this may be an integer multiple of the number of poles (e.g., two, four, six, eight, or more) of the rotor. The number of teeth (and/or slots) may also be an integer multiple of the number of phases of power the motor. The stator windings may also be arranged according to the number of poles and the number of phases of power delivered to the motor.

The rotor assembly 40 resides within the rotor chamber 34, and similar to the stator core 32, the rotor assembly 40 comprises a plurality of rotor laminations 42 aligned and adjacently placed with respect to one another to form a contiguous rotor core 44 with an outer diameter “Dᵣ”. End members 46 are disposed on opposite ends of the rotor core 44 and may be generally circular in cross-section with an outer diameter that generally approximates the diameter of the rotor laminations 42. Each rotor lamination 42 has a generally circular cross-section and is formed of a magnetic material, such as electrical steel. Extending from end-to-end, i.e., transverse to the cross-section, each lamination 42 includes features that, when aligned with adjacent laminations 42, form cumulative features that extend axially through the rotor core 44. For example, when assembled, the rotor laminations 42 cooperate to form a shaft chamber 47 located in the center of the lamination 42 that extends through the center of the rotor core 44 and that is configured to receive the rotor shaft 26 therethrough. The rotor shaft 26 is secured with respect to the rotor core 44 such that the rotor core and the rotor shaft rotate as a single entity about the rotor center axis 28. As described below in greater detail, in each lamination, magnet slots, and in the case of the LSIPM, rotor bar slots, may also cooperate to form passages extending through the rotor core 44. While FIG. 2 shows a configuration of the motor as a LSIPM motor with the rotor assembly 40 including rotor bars 48, disposed in the rotor core 44 electrically connected to rotor end members 46 to form the starting cage, these may be omitted in the non-line start IPM.

To support the rotor assembly 40, the exemplary motor 10 includes drive and opposite drive bearing sets 50,52, respectively, that are secured to the rotor shaft 26 and that facilitate rotation of the rotor assembly 40 within the stationary stator core 32. During operation of the motor 10, the bearing sets 50,52 transfer the radial and thrust loads produced by the rotor assembly 40 to the motor housing. Each bearing set 50,52 includes an inner race 54 disposed circumferentially about the rotor shaft 26. The tight fit between the inner race 54 and the rotor shaft 26 causes the inner race 54 to rotate in conjunction with the rotor shaft 26. Each bearing set 50,52 also includes an outer race 56 and rotational elements 58, which are disposed between the inner and outer races 54,56. The rotational elements 58 facilitate rotation of the inner races 54 while the outer races 56 remain stationary and mounted with respect to the drive and opposite drive end caps 14,16. Thus, the bearing sets 50,52 facilitate rotation of the rotor assembly 40 while supporting the rotor assembly 40 within the motor housing, i.e., the frame 12 and the drive and opposite drive end caps 14,16. To reduce the coefficient of friction between the races 54, 56 and the rotational elements 58, the bearing sets 50,52 are coated with a lubricant. Although the drawings show the bearing sets 50, 52 with balls as rotational elements, the bearing sets may be other constructions, such as sleeve bearings, pin bearings, roller bearings, etc.

FIG. 3 shows a lamination 42A which has been optimized for use in a non-line start IPM motor. FIG. 4 shows the same lamination 42B after further processing to form rotor bar slots to allow its use in a LSIPM motor. As will be discussed below in greater detail, to maximize performance of both a non-line start IPM motor and a LSIPM motor during synchronous steady state operation, the features of the laminations 42A, 42B may be selected to provide for low cogging and maximum torque per ampere. In one aspect of the disclosure, the features of the laminations 42A, 42B may be selected to provide a large magnet size and magnet alignment with the stator in a specific manner to accommodate low cogging. The angle of the magnets, the width of the poles, and the positions of the leading edge and trailing edge of the pole relative to the stator teeth and the direction of rotation (“ [symbol] ”) may be selected as desired to limit cogging. The terms “leading” and “trailing” are simply used for convenient reference relative to the direction of rotation (“ [symbol] ”). Arranging the leading edge of each pole to align with a stator tooth and arranging the trailing edge of the respective pole to be generally not aligned with a stator tooth may reduce cogging torque. In addition, to utilize the lamination 42A as shown in FIG. 3 in connection with a LSIPM motor, through further processing to include rotor bars slots as shown in FIG. 4, the lamination also requires sufficient material for the rotor bars.

With these considerations in mind the rotor laminations 42A, 42B may be formed with magnet slots 70 and magnets 72 arranged in V configuration at a magnet angle 74 to form a pole width 76 defined by leading and trailing edges 77, 78 that provides a sufficient area in the lamination for the rotor bars between the magnets while providing magnet alignment to accommodate low cogging. The magnet angle may correspond to the angle formed between the edges of adjacent magnet slots. The magnet angle may also correspond to an angle between reference lines passing through points on adjacent magnets where the pole of each magnet changes direction. For instance, adjacent magnets may have a north pole on one side of each of the magnets and a south pole on another side of each of the magnets. The magnet angle may correspond to the angle between a first reference line passing through a center plane of one magnet where the poles switch direction and a second reference line passing through a center plane of an adjacent magnet where the poles switch direction. The magnets 72 may be rotationally symmetrically disposed about the axis of rotation and generally define the poles of the motor. Depending on the number of poles, the magnets 72 may be disposed in different repetition patterns, such as at intervals of 180 degrees, 60 degrees, 45 degrees, etc, for example. The magnets may be magnetized in a generally radial direction to establish inwardly and outwardly disposed north and south poles on the magnets. This means that adjacent magnets cooperate to establish alternate north and south poles on the periphery of the rotor. The rotor may be constructed with any even number of poles. An exemplary lamination for a four pole motor non-LS, IPM motor is shown in FIG. 3 and the same lamination used in a LSIPM motor is shown in FIG. 4. The angle between the magnets of a pole, along with other parameters, generally defines the pole width, the position of the leading edge 77, and the position of the trailing edge 78. The magnet angle 74 may be obtuse, for example, approximately 109, 111, 113, 115, 117, 119, 121, 123, 125, 127, or 129 degrees. Alternatively, or additionally, the width of the magnets may be selected to achieve a desired pole width 76. While the widths and edges of the poles generally correspond with the angular positions of edges of the magnets, the width and edges of a pole are not exclusively a function of the size of the permanent magnets associated with the pole. More generally, the edge of a pole may be defined as the location where there is a distinct change in the air gap flux density. For instance, the air gap flux density may change by more than 30%, 40%, 50%, 60%, 70%, 80%, or more (relative to the flux density in the direction of magnetization) near the edges of the pole. Thus, the pole width may be influenced by the flux field, and the flux field may be shaped by, for example, the shape and magnetic properties of the materials in the stator, the rotor, the space between the stator and rotor, air gaps in the rotor laminations, or materials with different magnetic properties introduced to the stator, the rotor, and/or the space between the stator and the rotor. There may be only one magnet per slot or multiple magnets per slot.

As shown in the drawings by example and not in any limiting sense, the magnets may establish a direct axis 80 and a quadrature axis 82. The magnets define a general axis of magnetization (north or south pole) on the periphery of the rotor. The edges of the magnet slots facing the general axis of magnetization, which are radially outward from the magnets, establish a generally arcuate saturation boundary area as indicated by reference characters 84a,84b. The saturation boundary area may correspond to the pole width 74 depending upon the lamination design. The saturation boundary area may also be different from the pole width depending upon the lamination design. Generally speaking, the edges of the magnet slots and the edges of the magnets both face the general axis of magnetization.

In each of the designs of the laminations shown in FIGS. 3-4, the magnet slots 70 extend to the peripheral edge of the rotor Dᵣ such that an end of the magnet slot is adjacent the peripheral edge. One or more of the magnet slots may have its radially outward end at generally the same radial position relative to the rotor outer diameter Dᵣ and the rotor bar slots as shown in the drawings, or one or more magnet slots may extend radially outward and terminate at different distances relative to each other and/or the rotor bar slots, depending upon the application. The magnets 72 disposed in the magnet slots 70 have a smaller longitudinal length in the direction of the magnet slots than the magnet slots such that the magnet when installed in the magnet slot forms a magnet slot aperture 86 between the end of the permanent magnet and the magnet slot. The magnet slot aperture 86 may be filled with conductive material to form additional rotor bars that are also connected to the end members 46.

As explained below, the shape of the poles and the size of the pole width relative to the size of the stator tooth pitch may be arranged to limit adverse cogging. The poles may be configured so that when the leading edges are between teeth, the trailing edge is aligned with a tooth. In other words, the magnets (and other aspects of the lamination) are arranged so that both edges 84a,84b of the pole (air gap flux density changes) do no align with stator teeth at the same time. That is, the poles are spatially desynchronized with the stator teeth. For purposes of illustration, FIGS. 3 and 4 depict an embodiment in which the pole width 76 as defined by leading and trailing edges 77,78 is such that the leading edge 77 is aligned with a tooth 90 when at the same time the trailing edge 78 is aligned with a slot 92. There may be varying degrees of desynchronization, for example, the smallest difference in angular size between the pole width and an integer multiple of the stator tooth pitch may be greater than or generally equal to 50%, 40% 30%, 20%, or 10% of the stator tooth pitch. In other words, the remainder of the pole width divided by the tooth pitch may be a variety of percentages of the tooth pitch. Advantageously, the lamination is configured so that the rotor exhibits relatively little cogging as the rotor rotates between the teeth of the stator. The number of stator teeth 37 may be set as an integer multiple of the number of poles, and the leading and trailing edges 77,78 of each of the pole are angularly disposed with respect to the stator teeth to reduce cogging torque.

With this general configuration, the lamination may be used directly in a non-line start IPM or further processed for use in a rotor of a LSIPM. In a LSPIM, the lamination 42 may be further processed to include a series of rotor bar slots 100 that are arranged at positions about the lamination such that when assembled, the rotor bar slots cooperate to form channels for the rotor bars that extend through the rotor core 44. The rotor bar slots 100 are spaced radially inward from the rotor outer diameter Dᵣ. As shown in the drawings, each of the rotor bar slots may extend radially outward to generally the same radial position relative to the rotor outer diameter Dᵣ, or one or more rotor bar slots may extend radially outward and terminate at different radial distances relative to the outer diameter Dᵣ, depending upon the application. The rotor bars 48 may present the same shape as the rotor bar slots 100 to provide a tight fit for the rotor bars 48 within the rotor bar slots. The rotor bars 48 may be manufactured with tight tolerances between the rotor bars and the rotor bar slots 100. The rotor bar slots may also be configured to receive electrically conductive material to form the rotor bars 48 for the starting cage of the motor. The conductive material may comprise a molten material introduced into the slots to form cast rotor bars. The end members may also be cast.

The rotor bars slots 100,102 forming the starting cage may have a different size, shape, and spacing about the center axis 28. The rotor bar slots 100 may be distributed about the rotor in a manner that is asymmetric rather than evenly distributed, i.e., asymmetric rather than equiangularly spaced, around the outer edge of the lamination surface. Additionally, the rotor bar slots may have an arbitrary shape. The rotor bar slots 100 that are disposed in the saturation boundary area 84a,84b form a cluster. At least two of the rotor bar slots of the cluster may vary in cross-sectional area by at least 10 percent. At least two of the rotor bar slots of the cluster may also vary dimensionally by at least 5 percent. The laminations may be stacked off-set to one another such that the rotor bar in the slot has a helix relative to the rotor axis of rotation. Additionally, a rotor bar slot 102 may be provided to align with the quadrature axis 82. The rotor bar slot 102 of the quadrature axis 82 may have a geometry which matches at least one of the rotor bar slots 100 aligned with the direct axis 80. Although some of the drawings show a plurality of rotor bar slots in the direct axis and one rotor bar slot in the quadrature axis, other variations may be used.

The lamination designs shown in FIGS. 3-4 are designed to optimize paths for flux over a range of conditions including at rated load. In the design of the lamination shown in FIG. 4, the arrangement of the rotor bars and the magnets allows for passage of rotor flux under a wide range of loads and operating conditions. In FIG. 4, the distance between the rotor bar slots disposed in the saturation boundary area 84a,84b and the magnet slots 70 is controlled so that preferably each rotor bar slot in the saturation boundary area is positioned away from an adjacent magnet slot by a distance that equals or exceeds four percent (4%) of the pole pitch. In other words, the closest approach distance of any one of the rotor bar slots in the saturation boundary area to an adjacent magnet slot must equal or exceed four percent of the pole pitch. The closest approach distance is referred to hereinafter as (“D_{rb-m}”) and is defined by the equation (“D_{rb-m}”)≧0.04×(“pp”). The pole pitch for the machine (“pp”) may be defined by the equation (“pp”)={(“D_{R}”)×(π)}/(“P”), where “D_{R}” is the diameter of the rotor and (“P”) is the number of poles for the machine as defined by the number of groups of permanent magnets. One or more of the rotor bar slots 100 in the saturation boundary area 84a,84b may be arranged to maintain this parameter relative to an adjacent magnet slot. Rotor bar slots outside of the saturation boundary area, for instance, rotor bar slots 102 generally aligned with the quadrature axis 82, may also be positioned to maintain this parameter relative to an adjacent magnet slot.

In the lamination design shown in FIG. 4, all of the rotor bar slots 100 in the saturation boundary area have a radial interior edge 106 which conforms generally to a side 104 of the magnet 72 in the adjacent magnet slot 70. Preferably, one or more of the rotor bar slots in the saturation boundary area may be formed to have a radial inward edge 106 which defines a reference plane generally parallel to the adjacent magnet. In this way, one or more of the rotor bar slots may have a distance to the adjacent magnet slot that meets or exceeds the four percent (4%) of the pole pitch (“pp”). Rotor bar slots outside of the saturation boundary area, for instance, rotor bar slots 102 generally aligned with the quadrature axis 82, may also be shaped in a similar manner to maintain this parameter.

While certain embodiments have been described in detail in the foregoing detailed description and illustrated in the accompanying drawings, those with ordinary skill in the art will appreciate that various modifications and alternatives to those details could be developed in light of the overall teachings of the disclosure. Particularly, the figures and exemplar embodiments of the rotor laminations are intended to show illustrative examples and not to be considered limiting in any sense. Accordingly, the particular arrangements disclosed are meant to be illustrative only and not limiting as to the scope of the invention which is to be given the full breadth of the appended claims and any and all equivalents thereof.

What is claimed is:

1. A method comprising:
providing a lamination for a rotor of a permanent magnet motor, the lamination having an outer diameter (D_{R}) and a center axis;
forming the lamination with magnet slots, the magnet slots being spaced radially inward of the lamination outer diameter with an radial outward end of the magnet slots being adjacent to the lamination outer diameter, the magnet slots being formed in a plurality of V-shaped arrangements with an obtuse angle, the V-shaped arrangements being equiangularly spaced about a center axis of the lamination and defining a number of poles (P) for the motor, each V-shaped arrangement defining a general axis of magnetization for each pole for the motor, each V-shaped arrangement having a leading edge and a trailing edge, the leading edge and trailing edge being arranged such that when the leading edge aligns with a stator tooth, the respective trailing edge is generally not aligned with a stator tooth, wherein a number of stator teeth of the motor is an integer multiple of the number of the poles, wherein edges of the magnet slots that face the general axis of magnetization define a saturation boundary area, wherein the saturation boundary area is sufficient in size to locate rotor bar slots therein; and
selecting the lamination for use in one of a line start permanent magnet motor and a permanent magnet motor.

2. The method of claim 1, further comprising forming rotor bar slots in the saturation boundary area in a cluster.

3. The method of claim 2, wherein at least two of the rotor bar slots of the cluster vary in cross sectional area by at least ten percent (10%).

4. The method of claim 2, wherein at least two of the rotor bar slots of the cluster vary dimensionally by at least five percent (5%).

5. The method of claim 1, further comprising forming rotor bar slots in the saturation boundary area, wherein the rotor bar slots are spaced from an adjacent magnet slot by a distance that is at least four percent of the pole pitch (“pp”), wherein the pole pitch (pp)=(π×D_{R})/(P).

6. The method of claim 5, further comprising forming at least one of the rotor bar slots to have a radially inward edge that defines a reference plane generally parallel to an adjacent magnet.

7. The method of claim 5, further comprising forming at least one of the rotor bar slots to have a radially inward edge which conforms generally to the shape of an adjacent magnet.

8. The method of claim 5, further comprising forming the rotor bar slots to have their respective radial edges spaced from their respective adjacent magnet slots at substantially the same distance.

9. The method of claim 1, further comprising forming rotor bar slots outside of the saturation boundary.

10. The method of claim 1, further comprising forming a radially outward end of the magnet slot to receive conductive material.

11. The method of claim 1, further comprising forming rotor bar slots such that the lamination is symmetric about the general axes of magnetization.

12. The method of claim 1, further comprising forming rotor bar slots such that radially outward ends of the rotor bars slots are spaced radially inward of the lamination outer diameter an amount substantially the same as spacing of the radial outward end of the magnet slots from the lamination outer diameter.

13. A method comprising:
providing a lamination for a rotor of a permanent magnet motor, the lamination having an outer diameter (D_{R}) and a center axis;
forming the lamination with magnet slots, the magnet slots being spaced radially inward of the lamination outer diameter with an radial outward end of the magnet slots being adjacent to the lamination outer diameter, the magnet slots being formed in a plurality of V-shaped arrangements, each V-shaped arrangement having the same obtuse angle and being equiangularly spaced about a center axis of the lamination, the V-shaped arrangements defining a number of poles (P) for the motor, each V-shaped arrangement defining a general axis of magnetization for each pole for the motor, each V-shaped arrangement at least in part defining a flux edge that does not generally align with a stator tooth at the same time that another flux edge generally aligns with a stator tooth, wherein a number of stator teeth of the motor is an integer multiple of the number of the poles, wherein edges of the magnet slots that face the general axis of magnetization define a saturation boundary area, wherein the saturation boundary area is sufficient in size to locate rotor bar slots therein; and
selecting the lamination for use in one of a line start permanent magnet motor and a permanent magnet motor.

14. The method of claim 13, further comprising forming rotor bar slots in the saturation boundary area in a cluster.

15. The method of claim 14, wherein at least two of the rotor bar slots of the cluster vary in cross sectional area by at least ten percent (10%).

16. The method of claim 14, wherein at least two of the rotor bar slots of the cluster vary dimensionally by at least five percent (5%).

17. The method of claim 13, further comprising forming rotor bar slots in the saturation boundary area, wherein the rotor bar slots are spaced from an adjacent magnet slot by a distance that is at least four percent of the pole pitch (“pp”), wherein the pole pitch (pp)=(π×D_{R})/(P).

18. The method of claim 17, further comprising forming at least one of the rotor bar slots to have a radially inward edge that defines a reference plane generally parallel to an adjacent magnet.

19. The method of claim 17, further comprising forming at least one of the rotor bar slots to have a radially inward edge which conforms generally to the shape of an adjacent magnet.

20. The method of claim 17, further comprising forming the rotor bar slots to have their respective radial edges spaced from their respective adjacent magnet slots at substantially the same distance.

21. The method of claim 13, further comprising forming rotor bar slots outside of the saturation boundary.

22. The method of claim 13, further comprising forming a radially outward end of the magnet slot to receive conductive material.

23. The method of claim 13, further comprising forming rotor bar slots such that the lamination is symmetric about the general axes of magnetization.

24. The method of claim 13, further comprising forming rotor bar slots such that radially outward ends of the rotor bars slots are spaced radially inward of the lamination outer diameter an amount substantially the same as spacing of the radial outward end of the magnet slots from the lamination outer diameter.
